(19) United States
(12) Patent Application Publication
(10) Pub. No.: US 2022/0412062 A1
(43) Pub. Date: Dec. 29, 2022

(54) Light-Emitting Water Outlet Structure

(71) Applicant: Purity (Xiamen) Sanitary Ware Co., LTD, Xiamen (CN)

(72) Inventors: Pawel Xie, Xiamen (CN); Kaiqing Xie, Xiamen (CN)

(73) Assignee: Purity (Xiamen) Sanitary Ware Co., LTD, Xiamen (CN)

(21) Appl. No.: 17/900,884

(22) Filed: Sep. 1, 2022

(30) Foreign Application Priority Data
Apr. 8, 2022 (CN) 202220813292.0

(51) Int. Cl. E03C 1/04; E03C 1/08

(52) U.S. Cl. CPC E03C 1/0408; E03C 1/08

(57) ABSTRACT

The present invention discloses a light-emitting water outlet structure, and relates to the technical field of bathroom accessories. The light-emitting water outlet structure provided by the present invention can stabilize the water flow, so that the water outflow is mild and stable; the emitted light is totally reflected in the water flow, so that the emitted light flows with the water flow, thus the length of the propagation path of the light in the water flow is increased, and a better visual effect is achieved.

### TECHNICAL FIELD

The present invention relates to the technical field of bathroom accessories, in particular to a light-emitting water outlet structure.

### BACKGROUND ART

With the improvement of the living standard, presently, lamps are added to bathroom products to improve the visual effect in the process of water outflow. For example, the Chinese Patent No. CN206112338U announced on Apr. 19, 2017 discloses a water flow pipe connector, which comprises a water inlet connector, a connector housing, a water flow hydroelectric generator, a circuit board with LEDs, and a water outlet connector, wherein the water inlet connector and the water outlet connector are respectively screwed and fixed to two ports of the connector housing, the circuit board with LEDs is fixed to one end of the water flow hydroelectric generator, and the water flow hydroelectric generator is fixedly nested in the connector housing and positioned in a water flow path of the connector housing.

The water flow hydroelectric generator is driven by the water flow to generate electric power and then supplies the electric power to the LEDs, so that light is emitted by the LEDs and flows with the water flow, thereby a light effect is achieved during water outflow. However, the water flow in the pipe becomes turbulent after flowing through the water flow hydroelectric generator, resulting in reflection, scattering, refraction and other effects of the light in the water flow, consequently the propagation path of the light is shortened, the appearance of the illuminated water flow is degraded, and the overall visual effect is poor.

### CONTENTS OF THE INVENTION

In view of the drawbacks in the prior art, the object of the present invention is to provide a light-emitting water outlet structure, which can stabilize the water flow, make the water flow mild and stable, so that the light flows with the water flow, the length of the propagation path of the light in the water flow is increased, and a better visual effect is achieved.

To attain the object described above, the present invention provides the following technical schemes:

A light-emitting water outlet structure, comprising a water outlet connector, a light emitter and a water outflow stabilizer, wherein

the water outlet connector is connected to a water source to introduce water flow from a water inflow end and make the water flow toward a water outflow end;

the light emitter is arranged between the water inflow end and the water outflow end in the water outlet connector and can emit light toward the water outflow end of the water outlet connector; a water flow guide space is arranged between an outer wall of the light emitter and an inner wall of the water outlet connector to guide the water flow to the water outflow end of the water outlet connector;

the water outflow stabilizer is arranged on the water outflow end of the water outlet connector and configured to stabilize the water flow before the water flows out;

wherein the water outlet connector introduces water flow and makes the water flow toward the water outflow stabilizer through the water flow guide space; and the water outflow stabilizer stabilizes the water flow before the water flows out, so that the emitted light is totally reflected in the flowing water.

Furthermore, the water outflow stabilizer comprises a water outflow end cap and a plurality of water flow mesh screens; the water outflow end cap is mounted on the water outflow end of the water outlet connector; and the water flow mesh screen is arranged on a surface of the water outflow end cap facing the light emitter, so as to guide the water to flow through the meshes.

Furthermore, a water flow guide groove is formed between two adjacent water flow guide bars to guide the water flow toward the water outflow stabilizer.

Furthermore, the water outflow stabilizer comprises a water outlet body; the water outlet body is provided with a plurality of water flow splitting ports to split the water flow into a plurality of water streams, which flow out respectively; and each water flow splitting port is provided with a plurality of partition plates extending from a center of the water flow splitting port to a circumferential wall of the water flow splitting port, and the partition plates are arranged at an interval.

Furthermore, a plurality of light emitters are provided in a quantity corresponding to the quantity of the water flow splitting ports, and the light emitters are arranged at positions corresponding to the positions of the water flow splitting ports, so as to provide light to the plurality of water streams respectively.

Furthermore, a plurality of light transmission wires are connected in a light emitting direction of the light emitter; and an end of each light transmission wire away from the light emitter extends into the water flow splitting port respectively, so as to distribute the light to the water flow splitting ports.

Furthermore, the water flow splitting port comprises a smooth section and a lamination section, which are in communication with each other; the smooth section has a smooth inner wall to guide the water flow toward the lamination section; an end of the lamination section away from the smooth section extends toward the water outflow end, and an inner wall of the lamination section is configured to receive the partition plates, so as to stabilize the water flow in laminates before the water flows out.

Furthermore, the light-emitting water outlet structure further comprises a power supply unit arranged in the water outlet connector; and the light emitter is configured as an electric light emitter and connected to the power supply unit, so that the light emitter emits light after being powered by the power supply unit.

Furthermore, the power supply unit is configured as a battery power source or a hydroelectric generator.

Furthermore, the power supply unit is connected with a control board for mounting the light emitter; and the control board can control the light brightness of the light emitter, and is provided with a temperature sensor for sensing the water temperature.

With the above technical schemes, the present invention has the following advantages over the prior art:

a. The water flow is introduced into the water outlet connector, flows through the water flow guide space to the water outflow stabilizer, is stabilized by the water outflow stabilizer and then flows out, thus the water outflow is mild and stable, and thereby the light emitted by the light emitter can be totally reflected in the water flow, so that the light flows along with the water flow, the length of the propagation path of the light in the water flow is increased, and a better visual effect is achieved;

b. The water flows through the meshes of the water flow mesh screen, so that the water flow is evenly distributed by the meshes, and a laminated flow stabilizing effect of the water flow is realized, thereby the light is totally reflected in the water flow, the length of the propagation path of the light in the water flow is increased, and a better visual effect is achieved;

c. The water flow is split and guided by the water flow guide bars, so that the water flow can stably flow to the water outflow stabilizer through the clearance between adjacent water flow guide bars after being split by the water flow guide bars, thus the water flow can be stabilized at the water outflow stabilizer, thereby the water outflow is mild and stable, the water flow stabilizing effect is improved, and the length of the propagation path of the light in the water flow is increased;

d. By using the water outlet body and the water flow splitting ports in combination, the water flow is split into a plurality of water streams and the water streams flow to the water flow splitting ports after the water stably flows through the water flow guide bars and the water flow guide grooves, and then the water streams are laminated by the partition plates in the water flow splitting ports and then flow out, thus the water flow stabilizing effect is improved, and the length of the propagation path of the light in the water flow is increased;

e. By utilizing a plurality of light emitters arranged opposite to the water flow splitting ports, a plurality of light beams flowing with the water streams can be provided, thereby the visual effect during water outflow is improved;

f. By using the light transmission wires to guide the light emitted from the light emitter, the light emitted from the light emitter can be split into a plurality of light beams by the plurality of light transmission wires, so as to achieve a desired light effect at the water flow splitting ports during water outflow, reduce the number of light emitters and decrease the cost of use;

g. The water flow is guided through the smooth section to converge and fill the flow path, then the water flow is guided into the lamination section, where the water flow is further laminated by the plurality of partition plates, so that the water flow stabilizing effect is improved, and the length of the propagation path of the light in the water flow is increased;

h. By using the control board and the temperature sensor in combination, the light brightness or color change of the light emitter can be adjusted and controlled according to the sensed water temperature change, so as to meet a variety of requirements of use.

### BRIEF DESCRIPTION OF DRAWINGS

FIG. 1 is a schematic exploded view of the light-emitting water outlet structure in an embodiment 1 of the present invention;

FIG. 2 is a schematic cross-sectional view of the light-emitting water outlet structure of the present invention, in which the power supply unit is a battery;

FIG. 3 is a schematic cross-sectional view of the light-emitting water outlet structure of the present invention, in which the power supply unit is a hydroelectric generator;

FIG. 4 is a schematic structural diagram of the water outlet connector in the present invention;

FIG. 5 is a schematic structural diagram of the control board in the present invention;

FIG. 6 is a schematic exploded view of the light-emitting water outlet structure in an embodiment 2 of the present invention;

FIG. 7 is a cross-sectional view of the light-emitting water outlet structure in the embodiment 2 of the present invention;

FIG. 8 is a schematic structural diagram of the water outlet body in the present invention;

FIG. 9 is a cross-sectional view of the light-emitting water outlet structure in an embodiment 3 of the present invention;

FIG. 10 is a schematic structural diagram of the control board in the embodiment 3 of the present invention.

In the figures: 1—water outlet connector; 2—light emitter; 21—light transmission wire; 3—water outflow stabilizer; 31—water outflow end cap; 32—water flow mesh screen; 33—water outlet body; 331—water flow splitting port; 3311—smooth section; 3312—lamination section; 332—partition plate; 4—water flow guide bar; 5—water flow guide groove; 6—power supply unit; 7—control board; 8—temperature sensor.

### EMBODIMENTS

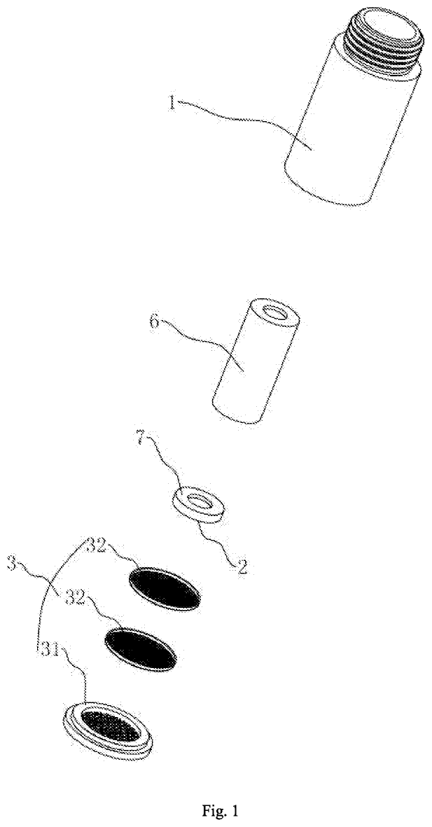

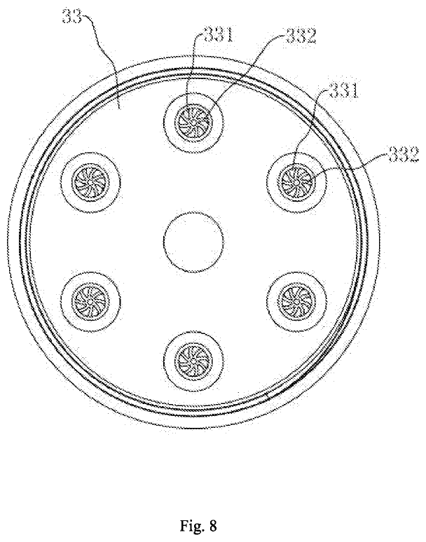

The light-emitting water outlet structure will be further explained with reference to FIGS. 1-10.

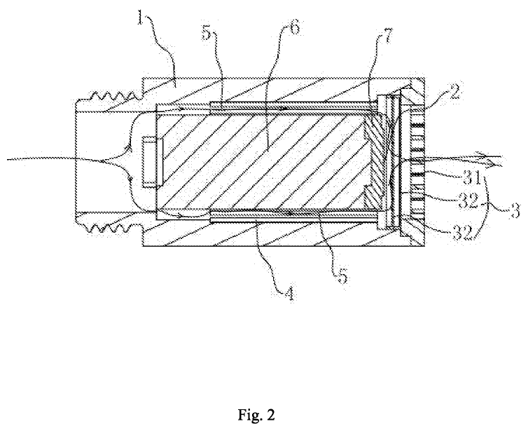

Embodiment 1: A light-emitting water outlet structure used at sanitary water outlets such as faucets, showers, etc., which can stabilize the water outflow and provide a light effect during water outflow, is provided. As shown in FIGS. 1 and 2, the water outlet structure comprises a water outlet connector 1, a power supply unit 6, a light emitter 2 and a water outflow stabilizer 3, wherein the power supply unit 6, the light emitter 2 and the water outflow stabilizer 3 are mounted in the water outlet connector 1 sequentially in the axial direction of the water outlet connector 1; in addition, there is a water flow guide space between the outer circumferential wall of the power supply unit 6 and the inner wall of the water outlet connector 1 and between the outer circumferential wall of the light emitter 2 and the inner wall of the water outlet connector 1 respectively, so as to guide the water flow to a water outflow end of the water outlet connector 1, so that light is led out after the water flows out of the water outlet connector 1, and the light is totally reflected in the water flow, thereby the light is propagated along with the water flow, the propagation path of the light in the water flow is longer, and a better visual effect is achieved.

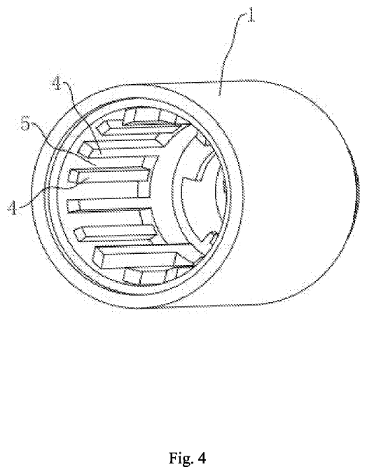

As shown in FIGS. 2 and 4, a plurality of water flow guide bars 4 are distributed at an interval on the inner wall of the water outlet connector 1, and the water flow guide bars 4 are evenly distributed in the circumferential direction of the inner wall of the water outlet connector 1, and extend linearly from the water inflow end toward the water outflow end of the water outlet connector 1, so that a water flow guide groove 5 for guiding and splitting the water flow can be formed between every two adjacent water flow guide bars 4; thus, after the water flow is introduced into the water outlet connector 1, the water flows through the water flow guide space to the water flow guide bars 4 and the water flow guide grooves 5 on the circumferential wall of the water outlet connector 1 owing to a blocking effect of the power supply unit 6 and the light emitter 2 in the water outlet connector 1, and then the water flow is stabilized by the water flow guide bars 4 and the water flow guide grooves 5, thereby the water flow attains certain stability and a desired water outflow effect is achieved.

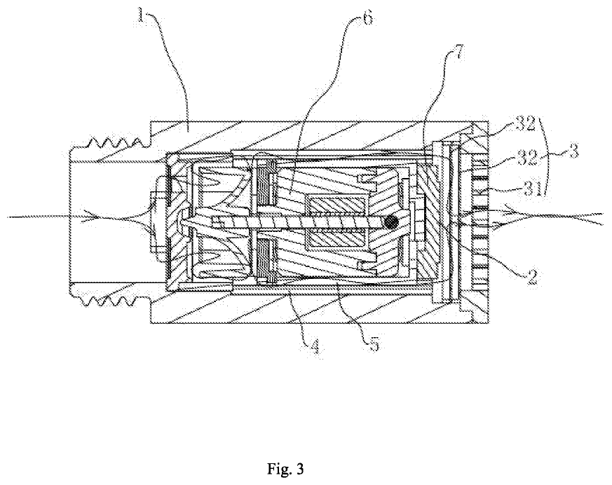

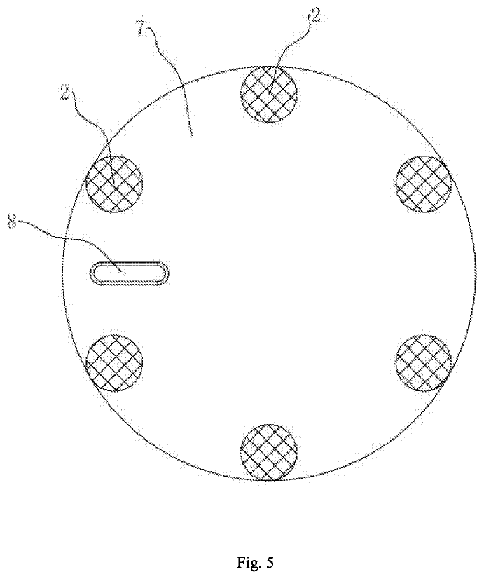

As shown in FIGS. 2 and 3, the power supply unit 6 is configured as a battery power source or a hydroelectric generator, which can be selected according to the requirement of use, as long as the power supply unit 6 can supply electric power to the light emitter 2. The light emitter 2 is configured as an electric light-emitting element and connected to the power supply unit 6, so that the light emitter 2 emits light after being powered by the power supply unit 6. Specifically, the light emitter 2 is configured as a LED lamp or SMD lamp, which can emit light after being powered. As shown in FIG. 5, in order to control the light brightness and color change of the light emitters 2 conveniently, the power supply unit 6 is connected to a control board 7, and the light emitters 2 are mounted on the control board 7, so that the control board 7 can control the light brightness or color change of the light emitters 2; in addition, a temperature sensor 8 for sensing the temperature of the water flow is mounted on the control board 7, and the temperature sensor 8 may be a thermocouple or thermistor, etc., so that the control board 7 can adjust the light brightness or color change of the light emitters 2 synchronously when the temperature sensor 8 senses the temperature change of the water flow, in order to meet a variety of requirements of use.

As shown in FIGS. 1 and 2, the water outflow stabilizer 3 is arranged on the water outflow end of the water outlet connector 1 and configured to stabilize the water flow before the water flows out; after water flow is introduced into the water outlet connector 1, the water flow is split and guided by the water flow guide bars 4 in combination with the water flow guide grooves 5, and then the water outflow is stabilized by the water outflow stabilizer 3, so as to achieve a water flow stabilizing effect, thereby the light is totally reflected in the water, and the water carries the light and flows out of the water outflow end of the water outlet connector 1, till the water flow encounters an barrier, where the light creates a light and shadow effect on the surface of the barrier.

Specifically, the water outflow stabilizer 3 comprises a water outflow end cap 31 and a plurality of water flow mesh screens 32; the water outflow end cap 31 is mounted on the water outflow end of the water outlet connector 1, and is configured in a grid shape to split and stabilize the water flow; the water flow mesh screens 32 are arranged on a surface of the water outflow end cap 31 facing the light emitter 2, and is mounted on the water outflow end of the water outlet connector 1, so as to guide the water flow through the meshes. After the water flow is further stabilized by the water flow mesh screens 32, the water flows out of the water outflow end cap 31; thus, the water flow is stable and clear, without any turbulence; the light is totally reflected in the water flow, and flows with the water flow, till the water flow encounters a barrier, where the flow lines of the fluid begin to fluctuate, thus the water flow becomes turbulent, and then the light creates a light and shadow effect at the place where the water flow state is changed.

As shown in FIGS. 1 and 2, furthermore, two water flow mesh screens 32 are provided and arranged at an interval in the water flow direction; in addition, the water flow mesh screens 32 have gradually increased mesh numbers in the water flow direction, so that the water flow is evenly distributed and the speed of the water flow is decreased after the water flow passes through the water flow mesh screens 32, and the collisions among vortices and the inertial resistance of the water flow are reduced; thus, the water flows out stably, and the light is guided to be totally reflected in the water flow and flows further along with the water flow, and the water flow will not splash easily when it encounters a barrier.

Working principle: After the water flows into the water outlet connector 1, the water flow is laminated and guided by the water flow guide bars 4 and the water flow guide grooves 5 on the inner circumferential wall of the water outlet connector 1 to stabilize the water flow, reduce vortex turbulence among the laminates, and make the water flow transited from turbulent flow to laminar flow (steady flow); then, the power supply unit 6 supplies electric power to the light emitter 2, so that the light emitter 2 emits light, and the light flows along with the water flow; when the water flows to the water outflow stabilizer 3, the water flow is evenly distributed by the two water flow mesh screens 32, and then the water flow is laminated and guided by the grids on the water outflow end cap 31, so as to further reduce the collisions among vortices, thereby reduce the inertial resistance of the water flow; thus, the water flows out stably, the light is totally reflected in the water flow and flows along with the water flow, and can be carried by the water flow further away, till the water flow encounters a barrier, where the light creates a light and shadow effect on the barrier. With the above schemes, the light-emitting water outlet structure provided by the present invention can stabilize the water flow, and make the water outflow mild and stable, so that the light can flow along with the water flow, the length of the propagation path of the light in the water flow can be increased, and a better visual effect can be achieved.

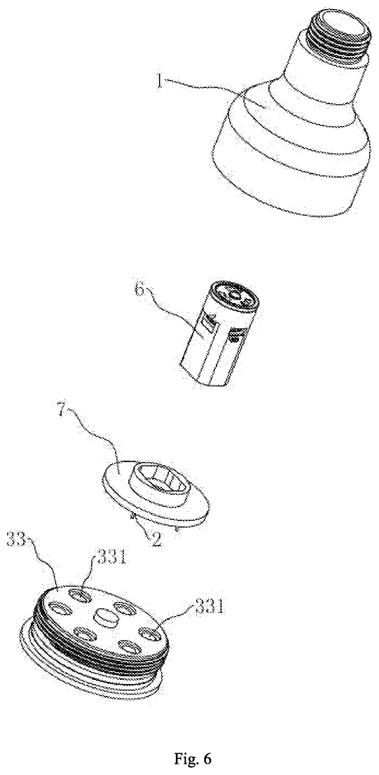

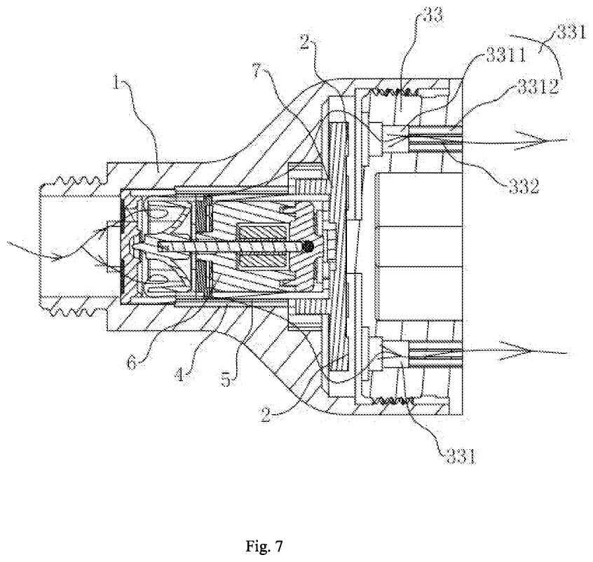

Embodiment 2: As shown in FIGS. 6 and 7, the difference between this embodiment and the embodiment 1 is that the water outflow stabilizer 3 includes a water outlet body 33; a plurality of water flow splitting ports 331 are evenly distributed on the water outlet body 33 in the circumferential direction of the water outlet body 33, so that the water flow can be split into a plurality of water streams; and each water flow splitting port 331 is provided with a plurality of partition plates 332 extending from the center of the water flow splitting port 331 to the circumferential wall of the water flow splitting port 331, and the partition plates 332 are evenly distributed at an interval; thus, the water flow can be split into a plurality of water streams by the water flow splitting ports 331 after passing through the water outlet connector 1, and the water flow is stabilized in the water flow splitting ports 331 by the partition plates 332, so that the water outflow through the water flow splitting ports 331 is stable.

As shown in FIGS. 6 and 7, furthermore, the water flow splitting port 331 comprises a smooth section 3311 and a lamination section 3312, which are in communication with each other; the smooth section 3311 has a smooth inner wall to guide the water flow toward the lamination section 3312; an end of the lamination section 3312 away from the smooth section 3311 extends toward the water outflow end, and the inner wall of the lamination section 3312 is configured to receive the partition plates 332, so as to stabilize the water flow in laminates before the water flows out. Both the smooth section 3311 and the lamination section 3312 have a water flow guiding function. When the water flows into the smooth section 3311, it converges in the smooth section 3311, thereby the collisions among vortices are reduced; then, when the water flows into the lamination section 3312, the water flow is split by the partition plates 332 in the lamination section 3312, thereby the water flow speed is decreased, the water flow is guided and laminated, and the stability of water outflow is improved.

As shown in FIGS. 5, 7 and 8, a plurality of light emitters 2 are provided in a quantity corresponding to the quality of the water flow splitting ports 331, and the positions of the light emitters 2 correspond to the positions of the water flow splitting ports 331, so as to provide light to the plurality of water streams respectively; thus, the plurality of light emitters 2 can be used to emit light simultaneously, thereby light flow is provided for the plurality of water streams; thus, a plurality of light beams are provided in the water streams, and, when the water flow encounters a barrier, an effect of dispersed light and shadows can be created according to the number of the water streams, thereby the visual effect is improved.

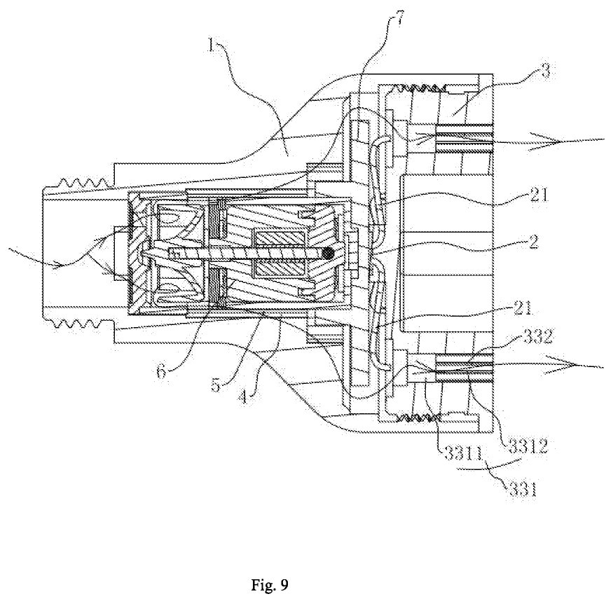

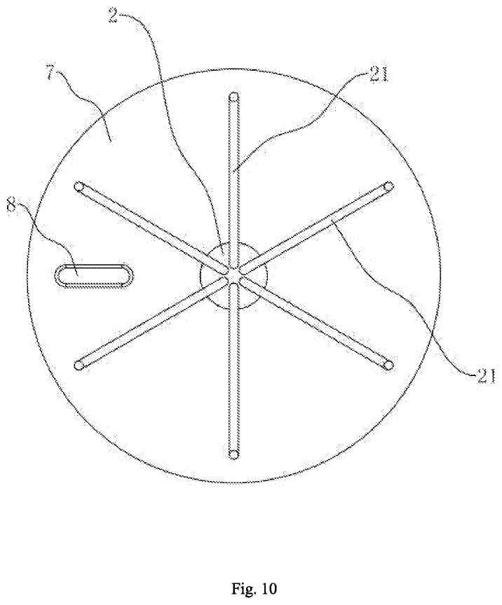

Embodiment 3: As shown in FIGS. 9 and 10, the difference between this embodiment and the embodiment 2 is that a plurality of light transmission wires 21 are connected in the light emitting direction of the light emitter 2; the end of each light transmission wire 21 away from the light emitter 2 extends into the water flow splitting port 331, so as to distribute the light to the water flow splitting ports 331, thereby the light emitted from the light emitter 2 extends to the water flow splitting ports 331 through the light transmission wires 21; thus, an effect of providing light to a plurality of water streams from one light emitter 2 and carrying the light to more places is achieved.

While some preferred embodiments of the present invention are described above, the scope of protection of the present invention is not limited to those embodiments. All technical schemes conceived on the basis of the idea of the present invention shall be deemed as falling in the scope of protection of the present invention. It should be pointed out that those skilled in the art can make various improvements and modifications without departing from the principle of the present invention, but all those improvements and modifications should be deemed as falling in the scope of protection of the present invention.

1. A light-emitting water outlet structure, comprising a water outlet connector, a light emitter and a water outflow stabilizer, wherein
the water outlet connector is connected to a water source to introduce water flow from a water inflow end and make the water flow toward a water outflow end;
the light emitter is arranged between the water inflow end and the water outflow end in the water outlet connector and can emit light toward the water outflow end of the water outlet connector; a water flow guide space is arranged between an outer wall of the light emitter and an inner wall of the water outlet connector to guide the water flow to the water outflow end of the water outlet connector;
the water outflow stabilizer is arranged on the water outflow end of the water outlet connector and configured to stabilize the water flow before the water flows out;
wherein the water outlet connector introduces water flow and makes the water flow toward the water outflow stabilizer through the water flow guide space; and the water outflow stabilizer stabilizes the water flow before the water flows out, so that the emitted light is totally reflected in the flowing water.

2. The light-emitting water outlet structure of claim 1, wherein the water outflow stabilizer comprises a water outflow end cap and a water flow mesh screen; the water outflow end cap is mounted on the water outflow end of the water outlet connector; and the water flow mesh screen is arranged on a surface of the water outflow end cap facing the light emitter, so as to guide the water to flow through the meshes.

3. The light-emitting water outlet structure of claim 1, wherein a plurality of water flow guide bars are distributed at an interval on the inner wall of the water outlet connector; and the water flow guide bars extend from the water inflow end of the water outlet connector toward the water outflow end of the water outlet connector.

4. The light-emitting water outlet structure of claim 1, wherein the water outflow stabilizer comprises a water outlet body; the water outlet body is provided with a plurality of water flow splitting ports to split the water flow into a plurality of water streams, which flow out respectively;
and each water flow splitting port is provided with a plurality of partition plates extending from a center of the water flow splitting port to a circumferential wall of the water flow splitting port, and the partition plates are arranged at an interval.

5. The light-emitting water outlet structure of claim 4, wherein a plurality of light emitters are provided in a quantity corresponding to the quantity of the water flow splitting ports, and the light emitters are arranged at positions corresponding to the positions of the water flow splitting ports, so as to provide light to the plurality of water streams respectively.

6. The light-emitting water outlet structure of claim 4, wherein a plurality of light transmission wires are connected in a light emitting direction of the light emitter; and an end of each light transmission wire away from the light emitter extends into the water flow splitting port respectively, so as to distribute the light to the water flow splitting ports.

7. The light-emitting water outlet structure of claim 4, wherein the water flow splitting port comprises a smooth section and a lamination section, which are in communication with each other; the smooth section has a smooth inner wall to guide the water flow toward the lamination section; an end of the lamination section away from the smooth section extends toward the water outflow end, and an inner wall of the lamination section is configured to receive the partition plates, so as to stabilize the water flow in laminates before the water flows out.

8. The light-emitting water outlet structure of claim 1, further comprising a power supply unit arranged in the water outlet connector; and the light emitter is configured as an electric light emitter and connected to the power supply unit, so that the light emitter emits light after being powered by the power supply unit.

9. The light-emitting water outlet structure of claim 8, wherein the power supply unit is configured as a battery power source or a hydroelectric generator.

10. The light-emitting water outlet structure of claim 8, wherein the power supply unit is connected with a control board for mounting the light emitter; and the control board can control the light brightness of the light emitter, and is provided with a temperature sensor for sensing the water temperature.
